(19) United States
(12) Patent Application Publication
(10) Pub. No.: US 2024/0428760 A1
(43) Pub. Date: Dec. 26, 2024

(54) SOUND GENERATION METHOD, SOUND GENERATION SYSTEM, AND PROGRAM

(71) Applicant: Yamaha Corporation, Hamamatsu (JP)

(72) Inventor: Masanari NISHIMURA, Hamamatsu (JP)

(21) Appl. No.: 18/823,009

(22) Filed: Sep. 3, 2024

Related U.S. Application Data
(63) Continuation of application No. PCT/JP2023/007586, filed on Mar. 1, 2023.

(30) Foreign Application Priority Data
Mar. 7, 2022 (JP) 2022-034567

(51) Int. Cl. G10H 1/02

(52) U.S. Cl. CPC G10H 1/02

(57) ABSTRACT

A sound generation method that is realized by a computer system includes acquiring a first control data sequence representing a feature of a note sequence and a second control data sequence representing a performance motion for controlling an attack of a musical instrument sound corresponding to each note of the note sequence, and processing the first control data sequence and the second control data sequence with a trained first generative model, thereby generating a sound data sequence representing a musical instrument sound of the note sequence having an attack corresponding to the performance motion represented by the second control data sequence.

### CROSS-REFERENCE TO RELATED APPLICATIONS

This application is a continuation application of International Application No. PCT/JP2023/007586, filed on Mar. 1, 2023, which claims priority to Japanese Patent Application No. 2022-034567 filed in Japan on Mar. 7, 2022. The entire disclosures of International Application No. PCT/JP2023/007586 and Japanese Patent Application No. 2022-034567 are hereby incorporated herein by reference.

### BACKGROUND

### Technological Field

The present disclosure relates to technology for generating sound data representing musical instrument sounds.

### Background Information

Techniques for synthesizing desired sounds have been proposed in the prior art. For example, Blaauw, Merlijn, and Jordi Bonada. “A NEURAL PARAMETRIC SINGING SYNTHESIZER.” arXiv preprint arXiv: 1704.03809v3 (2017) discloses a technique for using a trained generative model to generate a synthesized sound corresponding to a note sequence supplied by a user.

### SUMMARY

However, with conventional synthesis technology, it is difficult to generate a synthesized sound that has an attack suited to a note sequence. For example, there are cases in which a musical sound, which should be produced having a clear attack according to the musical characteristics of the note sequence, is instead generated having an ambiguous attack. Given the circumstances described above, an object of one aspect of the present disclosure is to generate a sound data sequence of musical instrument sounds in which an appropriate attack is added to a note sequence.

In order to solve the problem described above, a sound generation method according to one aspect of this disclosure comprises: acquiring a first control data sequence representing a feature of a note sequence and a second control data sequence representing a performance motion for controlling an attack of a musical instrument sound corresponding to each note of the note sequence; and processing the first control data sequence and the second control data sequence with a trained first generative model, thereby generating a sound data sequence representing a musical instrument sound of the note sequence having an attack corresponding to the performance motion represented by the second control data sequence.

A sound generation system according to one aspect of this disclosure comprises an electronic controller including at least one processor configured to acquire a first control data sequence representing a feature of a note sequence and a second control data sequence representing a performance motion for controlling an attack of a musical instrument sound corresponding to each note of the note sequence; and a process the first control data sequence and the second control data sequence with a trained first generative model, thereby generate a sound data sequence representing a musical instrument sound of the note sequence having an attack corresponding to the performance motion represented by the second control data sequence.

A non-transitory computer-readable medium storing a program according to one aspect of this disclosure causes a computer system to execute a process comprising acquiring a first control data sequence representing a feature of a note sequence and a second control data sequence representing a performance motion for controlling an attack of a musical instrument sound corresponding to each note of the note sequence; and processing the first control data sequence and the second control data sequence with a trained first generative model, thereby generating a sound data sequence representing a musical instrument sound of the note sequence having an attack corresponding to the performance motion represented by the second control data sequence.

### BRIEF DESCRIPTION OF THE DRAWINGS

FIG. 1 is a block diagram showing a configuration of an information system according to a first embodiment.

FIG. 2 is a block diagram showing a functional configuration of a sound generation system.

FIG. 3 is a schematic diagram of a second control data sequence.

FIG. 4 is a flowchart showing a detailed procedure of a synthesis process.

FIG. 5 is a block diagram showing a functional configuration of a machine learning system.

FIG. 6 is a flowchart showing a detailed procedure of a first learning process.

FIG. 7 is a flowchart showing a detailed procedure of the first learning process.

FIG. 8 is a block diagram showing a functional configuration of a sound generation system according to a fourth embodiment.

FIG. 9 is a schematic diagram of a second control data sequence according to a fifth embodiment.

FIG. 10 is a schematic diagram of a second control data sequence according to a modified example.

FIG. 11 is a schematic diagram of a second control data sequence according to a modified example.

FIG. 12 is a schematic diagram of a second control data sequence according to a modified example.

FIG. 13 is an explanatory diagram of a generative model in a modified example.

### DETAILED DESCRIPTION OF THE EMBODIMENTS

Selected embodiments will now be explained in detail below, with reference to the drawings as appropriate. It will be apparent to those skilled in the field from this disclosure that the following descriptions of the embodiments are provided for illustration only and not for the purpose of limiting the invention as defined by the appended claims and their equivalents.

### A: First Embodiment

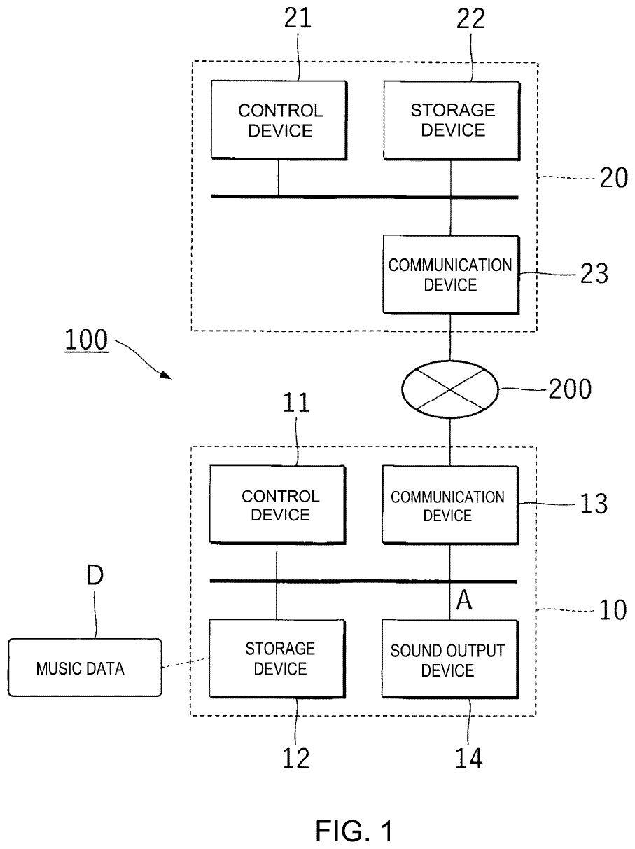

FIG. 1 is a block diagram showing a configuration of an information system 100 according to the first embodiment. The information system 100 includes a sound generation system 10 and a machine learning system 20. The sound generation system 10 and the machine learning system 20 communicate with each other via a communication network 200, such as the Internet.

### Sound Generation System 10

The sound generation system 10 is a computer system that generates a performance sound (hereinafter referred to as “target sound”) of a particular musical piece supplied by a user of the system. The target sound in the first embodiment is a musical instrument sound that has the timbre of a wind instrument.

The sound generation system 10 comprises a control device 11, a storage device 12, a communication device 13, and a sound output device 14. The sound generation system 10 is realized by an information terminal such as a smartphone, a tablet terminal, or a personal computer. The sound generation system 10 can be realized as a single device, or as a plurality of devices which are separately configured.

The control device (electronic controller) 11 includes one or more processors that control each element of the sound generation system 10. For example, the control device 11 includes one or more types of processors, such as a CPU (Central Processing Unit), a GPU (Graphics Processing Unit), an SPU (Sound Processing Unit), a DSP (Digital Signal Processor), an FPGA (Field Programmable Gate Array), an ASIC (Application Specific Integrated Circuit), and the like. The control device 11 generates a sound signal A representing a waveform of the target sound. The term “electronic controller” as used herein refers to hardware that executes software programs.

The storage device 12 includes one or more memory units (computer memories) for storing a program that is executed by the control device 11 and various data that are used by the control device 11. The storage device 12 includes a known storage medium, such as a magnetic storage medium or a semiconductor storage medium. The storage device 12 can include a combination of a plurality of types of storage media. Note that a portable storage medium that is attached to/detached from the sound generation system 10 or a storage medium (for example, cloud storage) that the control device 11 can access via the communication network 200 can also be used as the storage device 12.

The storage device 12 stores music data D that represent a musical piece supplied by a user. Specifically, the music data D specify the pitch and pronunciation period for each of a plurality of musical notes that constitute the musical piece. The pronunciation period is specified by, for example, a start point and duration of a musical note. For example, a music file conforming to the MIDI (Musical Instrument Digital Interface) standard can be used as the music data D. The user can include, in the music data D, information such as performance symbols representing a musical expression.

The communication device 13 communicates with the machine learning system 20 via the communication network 200. The communication device 13 that is separate from the sound generation system 10 can be connected to the sound generation system 10 wirelessly or by wire.

The sound output device 14 reproduces the target sound represented by the sound signal A. The sound output device 14 is, for example, a speaker (loudspeaker) or headphones, which provide sound to the user. Illustrations of a D/A converter that converts the sound signal A from digital to analog and of an amplifier that amplifies the sound signal A have been omitted for the sake of convenience. The sound output device 14 that is separate from the sound generation system 10 can be connected to the sound generation system 10 wirelessly or by wire.

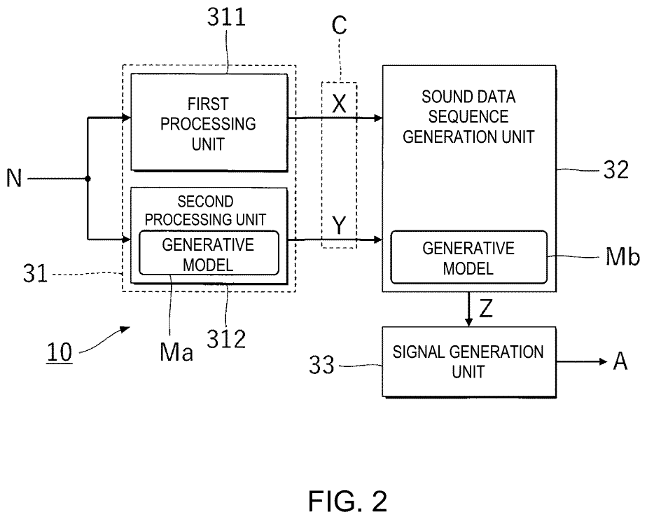

FIG. 2 is a block diagram showing a functional configuration of the sound generation system 10. The control device 11 realizes a plurality of functions (control data sequence acquisition unit 31, sound data sequence generation unit 32, and signal generation unit 33) for generating the sound signal A by the execution of a program that is stored in the storage device 12.

The control data sequence acquisition unit 31 acquires a first control data sequence X and a second control data sequence Y. Specifically, the control data sequence acquisition unit 31 acquires the first control data sequence X and the second control data sequence Y in each of a plurality of unit time intervals on a time axis. Each unit time interval is a time interval (hop size of a frame window) that is sufficiently shorter than the duration of each note of the musical piece. For example, the window size is 2-20 times of the hop size (the window is longer), the hop size is 2-20 milliseconds, and the window size is 20-60 milliseconds. The control data sequence acquisition unit 31 of the first embodiment comprises a first processing unit 311 and a second processing unit 312.

The first processing unit 311 generates the first control data sequence X from a note data sequence N for each unit time interval. The note data sequence N is a portion of the music data D corresponding to each unit time interval. The note data sequence N corresponding to any one unit time interval is a portion of the music data D that is within a time interval (hereinafter referred to as “processing time interval”) including said unit time interval. The processing time interval is a time interval including time intervals before and after the unit time interval. That is, the note data sequence N specifies a time series (hereinafter referred to as “note sequence”) of musical notes within a processing time interval in the musical piece represented by the music data D.

The first control data sequence X is data in a given format which represent a feature of a note sequence specified by the note data sequence N. The first control data sequence X in one given unit time interval is information indicating features of a musical note (hereinafter referred to as “target note”) including said unit time interval, from among a plurality of musical notes of a musical piece. For example, features indicated by the first control data sequence X include one or more features (such as pitch and, optionally, duration) of a musical note including said unit interval. In addition, the first control data sequence X includes information indicating one or more features of one or more musical notes other than the target note in the processing time interval. For example, the first control data sequence X includes a feature (for example, pitch) of the musical note before and/or the musical note after the musical note including said unit interval. Additionally, the first control data sequence X can include pitch difference between the target note and the immediately preceding or succeeding musical note.

The first processing unit 311 carries out prescribed computational processing on the note data sequence N to generate the first control data sequence X. The first processing unit 311 can generate the first control data sequence X using a generative model formed by a deep neural network (DNN), or the like. A generative model is a statistical estimation model in which the relationship between the note data sequence N and the first control data sequence X is learned through machine learning. The first control data sequence X is data specifying the musical conditions of the target sound to be generated by the sound generation system 10.

The second processing unit 312 generates the second control data sequence Y from the note data sequence N for each unit time interval. The second control data sequence Y is data in a given format which represent a performance motion of a wind instrument. Specifically, the second control data sequence Y represents a feature related to tonguing of each note during a performance of a wind instrument. Tonguing is a performance motion in which airflow is controlled (for example, blocked or released) by moving the performer's tongue. Tonguing controls acoustic characteristics of the attack of musical sound of a wind instrument, such as intensity or clarity. That is, the second control data sequence Y is data representing a performance motion for controlling the attack of a musical instrument sound corresponding to each note.

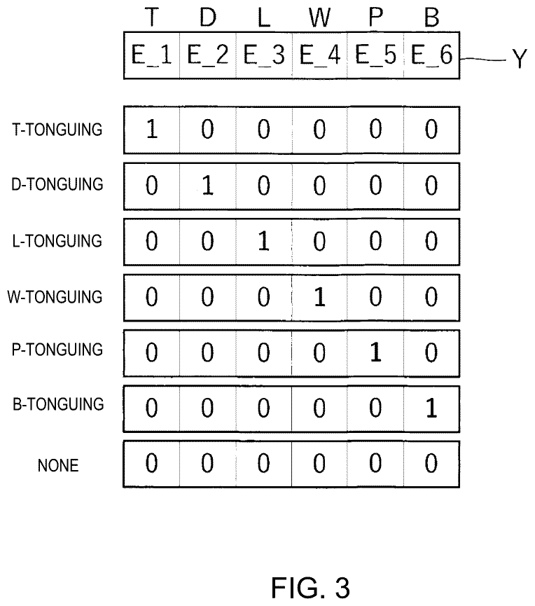

FIG. 3 is a schematic diagram of the second control data sequence Y. The second control data sequence Y in the first embodiment specifies the type of tonguing (hereinafter referred to as “tonguing type”). The tonguing type can be any one of six types (T, D, L, W, P, B) of tonguing shown below, or no tonguing at all. Tonguing type is a classification that focuses on the method of performing a wind instrument and the characteristics of the musical instrument sound. T-, D-, and L-tonguing are tonguing techniques that utilize the performer's tongue. On the other hand, W-, P-, and B-tonguing are tonguing techniques that use both the user's tongue and lips.

T-tonguing is a tonguing type with a large difference in volume between the attack and sustain of the musical instrument sound. T-tonguing approximates the pronunciation of a voiceless consonant, for example. That is, with T-tonguing, the airflow is blocked by the tongue immediately before the production of the musical instrument sound, so that there is a clear silent section before sound production.

D-tonguing is a tonguing type in which the difference in volume between the attack and sustain of the musical instrument sound is smaller than that in T-tonguing. D-tonguing approximates the pronunciation of a voiced consonant, for example. That is, with D-tonguing, the silent section before the production of sound is shorter than that in T-tonguing, so it is suitable for legato tonguing, in which successive musical instrument sounds are played in short succession.

L-tonguing is a tonguing type in which almost no change is observed in the attack and decay of the musical instrument sound. The musical instrument sound produced by L-tonguing is formed by only of sustain.

W-tonguing is a tonguing type in which the performer opens and closes the lips. Musical instrument sounds produced by W-tonguing display changes in pitch caused by the opening and closing of the lips during the attack and decay periods.

P-tonguing is a tonguing type in which the lips are opened and closed, similar to W-tonguing. P-tonguing is used when producing a stronger sound than in W-tonguing. B-tonguing is a tonguing type in which the lips are opened and closed, similar to P-tonguing. B-tonguing is achieved by bringing P-tonguing close to the pronunciation of a voiced consonant.

The second control data sequence Y specifies one of the six types of tonguing described above, or specifies that tonguing does not occur. Specifically, the second control data sequence Y is formed by six elements E_1 to E_6, corresponding to the different types of tonguing. The second control data sequence Y that specifies any one tonguing type is a one-hot vector in which, of the six elements E_1 to E_6, one element E corresponding to said type is set to “1” and the other five elements E are set to “0.” For example, in the second control data sequence Y representing T-tonguing, one element E_1 is set to “1” and the remaining five elements E_2 to E_6 are set to “0.” In addition, the second control data sequence Y in which all the elements E_1 to E_6 are set to “0” means that tonguing does not occur. The second control data sequence Y can be set in a one-cold format, in which the “1” and “0” in FIG. 3 are reversed.

As shown in FIG. 2, a generative model Ma is used for the generation of the second control data sequence Y by the second processing unit 312. The generative model Ma is a trained model in which the relationship between the note data sequence N as the input and the tonguing type as the output is learned through machine learning. That is, the generative model Ma outputs a tonguing type that is statistically appropriate for the note data sequence N. The second processing unit 312 processes the note data sequence N using the trained generative model Ma to estimate playing style data of each note, and further generates the second control data sequence Y for each unit time interval on the basis of the playing style data. Specifically, the second processing unit 312 uses the generative model Ma and, for each note, processes the note data sequence N that includes said note, to estimate the playing style data P indicating the tonguing type of that musical note, and to output the second control data sequence Y indicating the same tonguing type as that indicated by the playing style data P for each unit time interval corresponding to that musical note. That is, the second processing unit 312 outputs, for each unit time interval, the second control data Y that specifies the tonguing type estimated for the musical note that includes that unit time interval.

The generative model Ma is realized by a combination of a program that causes the control device 11 to execute a computation for estimating the playing style data P that indicate the tonguing type from the note data N, and a plurality of variables (specifically, weighted value and bias) that are applied to said computation. The program and the plurality of variables that realize the generative model Ma are stored in the storage device 12. The plurality of variables of the generative model Ma are set in advance through machine learning. The generative model Ma is one example of a “second generative model.”

The generative model Ma is formed by a deep neural network, for example. Any type of deep neural network, such as a recurrent neural network (RNN) or a convolutional neural network (CNN), can be used as the generative model Ma. The generative model Ma can be formed by a combination of a plurality of types of deep neural networks. In addition, an additional element such as long short term memory (LSTM) can be incorporated into the generative model Ma.

As shown in FIG. 2, a control data sequence C is generated for each unit time interval as a result of the above-mentioned process carried out by the control data sequence acquisition unit 31. The control data sequence C for each unit time interval includes the first control data sequence X generated by the first processing unit 311 for said unit time interval, and the second control data sequence Y generated by the second processing unit 312 for said unit time interval. The control data sequence C is data in which, for example, the first control data sequence X and the second control data sequence Y are concatenated with each other.

The sound data sequence generation unit 32 of FIG. 2 uses the control data sequence C (first control data sequence X and second control data sequence Y) to generate a sound data sequence Z. The sound data sequence Z is data in a given format which represent a target sound. Specifically, the sound data sequence Z represents a target sound that corresponds to the note sequence represented by the first control data sequence X and that has an attack corresponding to the performance motion represented by the second control data sequence Y. That is, the musical sound that is produced from the wind instrument, when the note sequence of the note data sequence N is performed with the performance motion represented by the second control data sequence Y, is generated as the target sound.

Specifically, each piece of sound data sequence Z is data representing a frequency spectrum envelope of the target sound. Specifically, in accordance with the control data sequence C for each unit time interval, the sound data sequence Z corresponding to said unit time interval are generated. The sound data sequence Z corresponds to a waveform sample sequence for one frame window, which is longer than the unit time interval. As described above, acquisition of the control data sequence C by the control data sequence acquisition unit 31 and generation of the sound data sequence Z by the sound data sequence generation unit 32 are executed for each unit time interval.

A generative model Mb is used for the generation of the sound data sequence Z by the sound data sequence generation unit 32. The generative model Mb estimates, for each unit time interval, the sound data sequence Z of said unit time interval on the basis of the control data sequence C of said unit time interval. The generative model Mb is a trained model in which the relationship between the control data sequence C as the input and the sound data sequence Z as the output is learned through machine learning. That is, the generative model Mb outputs the sound data sequence Z that is statistically appropriate for the control data sequence C. The sound data sequence generation unit 32 processes the control data sequence C using the generative model Mb to generate the sound data sequence Z.

The generative model Mb is realized by a combination of a program that causes the control device 11 to execute computation for generating the sound data sequence Z from the control data sequence C, and a plurality of variables (weighted value and bias) that are applied to said computation. The program and the plurality of variables that realize the generative model Mb are stored in the storage device 12. The plurality of variables of the generative model Mb are set in advance through machine learning. The generative model Mb is one example of a “first generative model.”

The generative model Mb is formed by a deep neural network, for example. Any type of deep neural network, such as a recurrent neural network (RNN) or a convolutional neural network (CNN), can be used as the generative model Mb. The generative model Mb can be formed by a combination of a plurality of types of deep neural networks. In addition, an additional element such as long short term memory (LSTM) can be incorporated into the generative model Mb.

The signal generation unit 33 generates the sound signal A of the target sound from a time series of the sound data sequence Z. The signal generation unit 33 converts the sound data sequence Z to a waveform signal in the time domain using computation including discrete inverse Fourier transform, for example, and concatenates the waveform signals for successive unit time intervals to generate the sound signal A. For example, a deep neural network that has learned the relationship between the sound data sequence Z and each sample of the sound signal A (so-called neural vocoder) can be used by the signal generation unit 33 to generate the sound signal A from the sound data sequence Z. The sound signal A generated by the signal generation unit 33 is supplied to the sound output device 14, and, as a result, the target sound is reproduced from the sound output device 14.

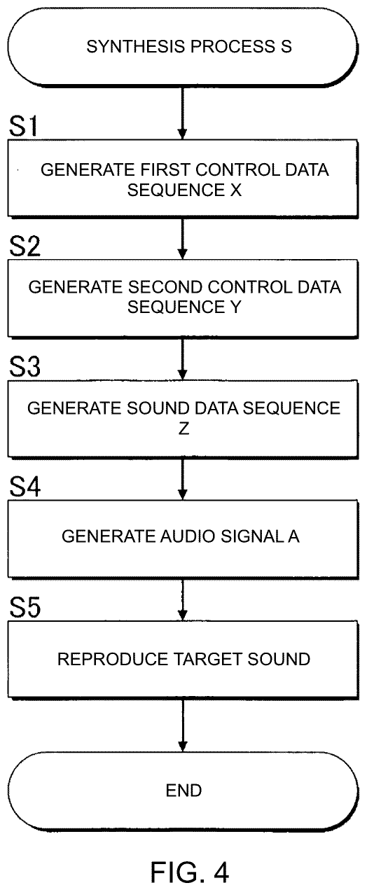

FIG. 4 is a flowchart showing a detailed procedure of a process (hereinafter referred to as “synthesis process”) S by which the control device 11 generates the sound signal A. The synthesis process S is executed for each of a plurality of unit time intervals.

When the synthesis process S is started, the control device 11 (first processing unit 311) generates, from the note data sequence N corresponding to a unit time interval of the music data D, the first control data sequence X for said unit time interval (S1). In addition, preceding the progression of the unit time interval, the control device 11 (second processing unit 312) processes, in advance, information of the note data sequence N using the generative model Ma with respect to a musical note that is about to start, to estimate the playing style data P indicating the tonguing type of that note, and generates, for each unit time interval, the second control data sequence Y of said unit time interval on the basis of the estimated playing style data P (S2). Regarding how specifically to make the preceding estimation, the playing style data P can be estimated for a note that starts one or several unit time intervals before, or, when entering the unit time interval of a particular musical note, the playing style data P of the following note can be estimated. The order of the generation of the first control data sequence X (S1) and the generation of the second control data sequence Y (S2) can be reversed.

The control device 11 (sound data sequence generation unit 32) processes the control data sequence C including the first control data sequence X and the second control data sequence Y using the generative model Mb to generate the sound data sequence Z of a unit time interval (S3). The control device 11 (signal generation unit 33) generates the sound signal A for a unit time interval from the sound data sequence Z (S4). Waveform signals for one frame window, which is longer than the unit time interval, are generated from the sound data sequence Z of each unit time interval, which are subjected to overlap-addition to generate the sound signal A. The time difference (hop size) between the previous and following frame windows corresponds to the unit time interval. The control device 11 supplies the sound signal A to the sound output device 14 to reproduce the target sound (S5).

As described above, in the first embodiment, the second control data sequence Y representing the performance motion (specifically, tonguing) for controlling an attack of a musical instrument sound is used, in addition to the first control data sequence X representing a feature of the note sequence, for the generation of the sound data sequence Z. Accordingly, compared to a mode in which the sound data sequence Z is generated only from the first control data sequence X, it is possible to generate the sound data sequence Z of target sounds with an appropriate attack added to the note sequence. In the first embodiment in particular, the second control data sequence Y representing a feature relating to the tonguing of a wind instrument is used for the generation of the sound data sequence Z. Accordingly, it is possible to generate the sound data sequence Z of natural musical instrument sounds that appropriately reflect differences in the attack in accordance with tonguing features.

### Machine Learning System 20

The machine learning system 20 of FIG. 1 is a computer system that constructs the generative model Ma and the generative model Mb used by the sound generation system 10 through machine learning. The machine learning system 20 comprises a control device 21, a storage device 22, and a communication device 23.

The control device (electronic controller) 21 includes one or a plurality of processors that control each element of the machine learning system 20. For example, the control device 21 includes one or more types of processors, such as a CPU, an SPU, a DSP, an FPGA, an ASIC, and the like. The term “electronic controller” as used herein refers to hardware that executes software programs.

The storage device 22 includes one or more memory units (computer memories) for storing a program that is executed by the control device 21 and various data that are used by the control device 21. The storage device 22 includes a known storage medium, such as a magnetic storage medium or a semiconductor storage medium. The storage device 22 can include a combination of a plurality of types of storage media. Note that, for example, a portable storage medium that is attached to/detached from the machine learning system 20 or a storage medium (for example, cloud storage) that the control device 21 can access via the communication network 200 can also be used as the storage device 22.

The communication device 23 communicates with the sound generation system 10 via the communication network 200. The communication device 23 that is separate from the machine learning system 20 can be connected to the machine learning system 20 wirelessly or by wire.

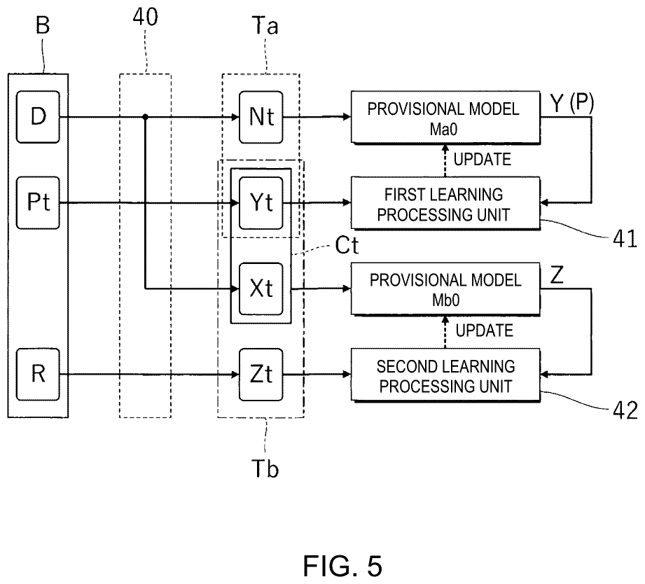

FIG. 5 is an explanatory diagram showing a function by which the machine learning system 20 constructs the generative model Ma and the generative model Mb. The storage device 22 stores a plurality of pieces of basic data B corresponding to different musical pieces. Each of the plurality of pieces of basic data B includes the music data D, playing style data Pt, and reference signal R.

The music data D are data representing a note sequence of a particular musical piece (hereinafter referred to as “reference musical piece”) that is being played in the waveform represented by the reference signal R. Specifically, as described above, the music data D specify the pitch and pronunciation period for each note of the reference musical piece. The playing style data Pt specify the performance motion of each note being performed in the waveform represented by the reference signal R. Specifically, the playing style data Pt specify one of the six types of tonguing described above, or specify that tonguing does not occur for each note of the reference musical piece. For example, the playing style data Pt are time-series data in which symbols, indicating various types of tonguing, or that tonguing does not occur, are arranged for each note. For example, a skilled wind instrument performer listens to the sound represented by the reference signal R and specifies, for each note of the reference musical piece, the presence/absence of tonguing and the appropriate type of tonguing when said note is to be performed. The playing style data Pt are generated in accordance with the performer's instruction. A determination model that determines the tonguing for each note from the reference signal R can be used for the generation of the playing style data Pt.

The reference signal R is a signal representing the waveform of the musical instrument sound that is produced from the wind instrument, when the reference musical piece is played using the performance motion specified by the playing style data Pt. For example, a skilled wind instrument performer actually plays the reference musical piece using the performance motion specified by the playing style data Pt. The musical instrument sounds produced by the performer is recorded to generate the reference signal R. After the recording of the reference signal R, the performer or a relevant party adjusts the position of the reference signal R on the time axis. The playing style data Pt are also added at that time. Accordingly, the musical instrument sound of each note in the reference signal R is produced having an attack corresponding to the type of tonguing specified for said note by the playing style data Pt.

The control device 21 realizes a plurality of functions (training data acquisition unit 40, first learning processing unit 41, and second learning processing unit 42) for generating the generative model Ma and the generative model Mb by the execution of a program that is stored in the storage device 22.

The training data acquisition unit 40 generates a plurality of pieces of training data Ta and a plurality of pieces of training data Tb from the plurality of pieces of basic data B. The training data Ta and the training data Tb are generated for each unit time interval of one reference musical piece. Accordingly, a plurality of pieces of training data Ta and a plurality of pieces of training data Tb are generated from each of a plurality of pieces of basic data B corresponding to different reference musical pieces. The first learning processing unit 41 constructs the generative model Ma through machine learning using the plurality of pieces of training data Ta. The second learning processing unit 41 constructs the generative model Mb through machine learning using the plurality of pieces of training data Tb.

Each of the plurality of pieces of training data Ta is formed by a combination of a note data sequence Nt for training and a playing style data Pt for training (tonguing type). When estimating the playing style data P of each note using the generative model Ma, information relating to a plurality of musical notes of the phrase that contains said note in the note data Nt of the reference musical piece is used. A phrase is a time interval that is longer than the processing time interval described above, and information relating to a plurality of musical notes can include the positions of the notes within the phrase.

A second control data sequence Yt of one musical note represents the performance motion (tonguing type) specified by the playing style data Pt for said note in the reference musical piece. The training data acquisition unit 40 generates the second control data sequence Yt from the playing style data Pt of each note. Each piece of playing style data Pt (or each piece of second control data sequence Yt) is formed by the six elements E_1 to E_6, corresponding to the different types of tonguing. The playing style data Pt (or the second control data sequence Yt) specify one of the six types of tonguing, or specify that tonguing does not occur. As can be understood from the foregoing explanation, the playing style data Pt of each piece of training data Ta represents the performance motion that is appropriate for each note in the note data sequence Nt of said training data Ta. That is, the playing style data Pt is a ground truth of the playing style data P that the generative model Ma should output in response to the input of the note data sequence Nt.

Each of the plurality of pieces of training data Tb is formed by a combination a control data sequence Ct for training and a sound data sequence Zt for training. The control data sequence Ct is formed by a combination of a first control data sequence Xt for training and a second control data sequence Yt for training. The first control data sequence Xt is one example of a “first training control data sequence” and the second control data sequence Yt is one example of a “second training control data sequence.” In addition, the sound data sequence Zt is one example of a “training sound data sequence.”

The first control data sequence Xt is data representing features of a reference note sequence represented by the note data sequence Nt, in the same manner as the above-mentioned first control data sequence X. The training data acquisition unit 40 generates the first control data sequence Xt from the note data sequence Nt by the same process as that of the first processing unit 311. The second control data sequence Yt represents the performance motion specified by the playing style data Pt for the musical note that includes the unit time interval of the reference musical piece. The second control data sequence Yt generated by the training data generation unit is used for both the training data Ta and the control data sequence Ct.

The sound data sequence Zt of one unit time interval is the portion of the reference signal R within said unit time interval. The training data acquisition unit 40 generates the sound data sequence Zt from the reference signal R. As can be understood from the foregoing explanation, the sound data sequence Zt represents the waveform of the musical instrument sound produced by the wind instrument, when the reference note sequence corresponding to the first control data sequence Xt is played using the performance motion represented by the second control data sequence Yt. That is, the sound data sequence Zt is s ground truth of the sound data sequence Z that the generative model Mb should output in response to the input of the control data sequence Ct.

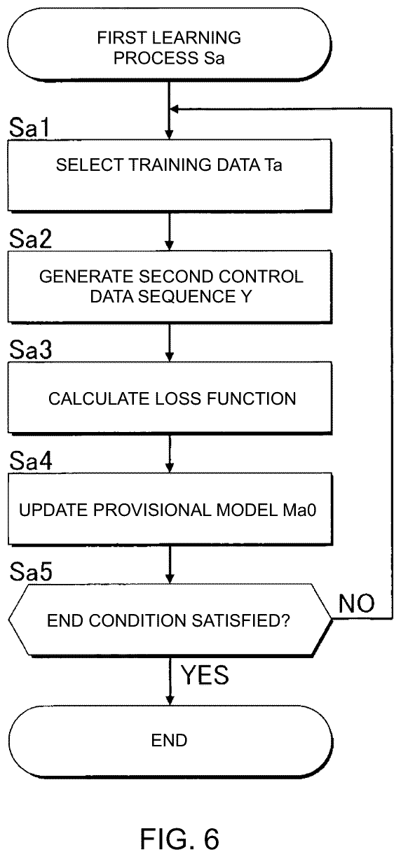

FIG. 6 is a flowchart of a process (hereinafter referred to as “first learning process”) Sa by which the control device 21 constructs the generative model Ma through machine learning. For example, the first learning process Sa is started, triggered by an instruction from an operator of the machine learning system 20. The control device 21 executes the first learning process Sa, thereby realizing the first learning processing unit 41 of FIG. 5.

When the first learning process Sa is started, the control device 21 selects one of a plurality of pieces of training data Ta (hereinafter referred to as “selected training data Ta”) (Sa1). As shown in FIG. 5, the control device 21 processes, for each note, the note data sequence Nt of the selected training data Ta using an initial or provisional generative model Ma (hereinafter referred to as “provisional model Ma0”) to generate the playing style data P of that note (Sa2).

The control device 21 calculates a loss function representing the error between the playing style data P generated by the provisional model Ma0 and the playing style data Pt of the selected training data Ta (Sa3). The control device 21 updates a plurality of variables of the provisional model Ma0 such that the loss function is reduced (ideally minimized) (Sa4). For example, the backpropagation method is used to update each variable in accordance with the loss function.

The control device 21 determines whether a prescribed end condition has been met (Sa5). The end condition is that the loss function falls below a prescribed threshold value, or, that the amount of change in the loss function falls below a prescribed threshold value. If the end condition is not satisfied (Sa5: NO), the control device 21 selects unselected training data Ta as the new selected training data Ta (Sa1). That is, the process (Sa1-Sa4) of updating the plurality of variables of the provisional model Ma0 is repeated until the end condition is satisfied (Sa5: YES). If the end condition is satisfied (Sa5: YES), the control device 21 ends the first learning process Sa. The provisional model Ma0 at the time that the end condition is satisfied is set as the trained generative model Ma.

As can be understood from the foregoing explanation, the generative model Ma learns the latent relationship between the tonguing type (playing style data Pt) as the output and the note data sequence Nt as the input in the plurality of pieces of training data Ta. Accordingly, the trained generative model Ma estimates, and outputs, the playing style data P that is statistically appropriate for an unknown note data sequence N from the viewpoint of that relationship.

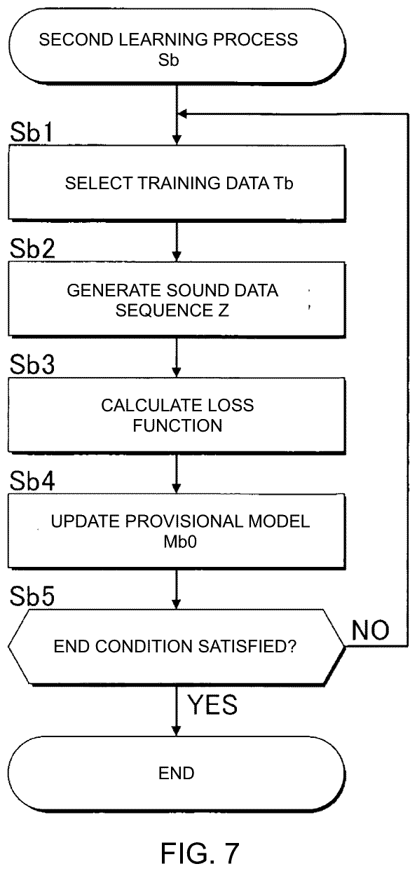

FIG. 7 is a flowchart of a process (hereinafter referred to as “second learning process”) Sb by which the control device 21 constructs the generative model Mb through machine learning. For example, the second learning process Sb is started, triggered by an instruction from an operator of the machine learning system 20. The control device 21 executes the second learning process Sb, thereby realizing the second learning processing unit 42 of FIG. 5.

When the second learning process Sb is started, the control device 21 selects one of a plurality of pieces of training data Tb (hereinafter referred to as “selected training data Tb”) (Sb1). As shown in FIG. 5, the control device 21 processes, for each unit time interval, the control data sequence Ct of the selected training data Tb using an initial or provisional generative model Mb (hereinafter referred to as “provisional model Mb0”) to generate the sound data sequence Z of that unit time interval (Sb2).

The control device 21 calculates a loss function representing the error between the sound data sequence Z generated by the provisional model Mb0 and the sound data sequence Zt of the selected training data Tb (Sb3). The control device 21 updates a plurality of variables of the provisional model Mb0 such that the loss function is reduced (ideally minimized) (Sb4). For example, the backpropagation method is used to update each variable in accordance with the loss function.

The control device 21 determines whether a prescribed end condition has been met (Sb5). The end condition is that the loss function falls below a prescribed threshold value, or, that the amount of change in the loss function falls below a prescribed threshold value. If the end condition is not satisfied (Sb5: NO), the control device 21 selects unselected training data Tb as the new selected training data Tb (Sb1). That is, the process (Sb1-Sb4) of updating the plurality of variables of the provisional model Mb0 is repeated until the end condition is satisfied (Sb5: YES). If the end condition is satisfied (Sb5: YES), the control device 21 ends the second learning process Sb. The provisional model Mb0 at the time that the end condition is satisfied is set as the trained generative model Mb.

As can be understood from the foregoing explanation, the generative model Mb learns the latent relationship between the sound data sequence Zt as the output and the control data sequence Ct as the input in the plurality of pieces of training data Tb. Accordingly, the trained generative model Mb estimates, and outputs, the sound data sequence Z that is statistically appropriate for an unknown control data sequence C from the viewpoint of that relationship.

The control device 21 transmits, from the communication device 23 to the sound generation system 10, the generative model Ma constructed by the first learning process Sa and the generative model Mb constructed by the second learning process Sb. Specifically, the plurality of variables defining the generative model Ma and the plurality of variables defining the generative model Mb are transmitted to the sound generation system 10. The control device 11 of the sound generation system 10 receives, with the communication device 13, the generative model Ma and the generative model Mb transmitted from the machine learning system 20 and stores the generative model Ma and the generative model Mb in the storage device 12.

### B: Second Embodiment

The second embodiment will be described. In each of the embodiments illustrated below, elements that have the same functions as those in first embodiment have been assigned the same reference symbols used to describe the first embodiment and detailed descriptions thereof have been appropriately omitted.

In the first embodiment, an example was presented in which a feature relating to the tonguing of a wind instrument is represented by the second control data sequence Y (and the playing style data P). In the second embodiment, the second control data sequence Y (and the playing style data P) represents features relating to inspiration or expiration when blowing a wind instrument. Specifically, the second control data sequence Y (and the playing style data P) of the second embodiment represents numerical values (hereinafter referred to as “blowing parameters”) related to the strength of inspiration or expiration when blowing. For example, the blowing parameters include expiration volume, expiration speed, inspiration volume, and inspiration speed. The acoustic characteristics of the attack of a wind instrument sound change in accordance with the blowing parameters. That is, the second control data sequence Y (and the playing style data P) of the second embodiment is data representing a performance motion for controlling the attack of a musical instrument sound, in the same manner as the second control data sequence Y of the first embodiment.

The playing style data Pt used in the first learning process Sa specifies the blowing parameters for each note of the reference musical piece. The second control data sequence Yt of each unit time interval represents the blowing parameters specified by the playing style data Pt for the musical note that includes said unit time interval. Accordingly, the generative model Ma constructed by the first learning process Sa estimates, and outputs, the playing style data P representing the blowing parameters that are statistically appropriate for the note data sequence N.

The reference signal R used in the second learning process Sb is a signal representing the waveform of the musical instrument sound that is produced from the wind instrument, when the reference musical piece is played using the blowing parameters specified by the playing style data Pt. Accordingly, the generative model Mb constructed by the second learning process Sb generates the sound data sequence Z of target sounds in which the blowing parameters represented by the second control data sequence Y are appropriately reflected on the attack.

The same effects as those of the first embodiment are realized in the second embodiment. In addition, in the second embodiment, the second control data sequence Y representing blowing parameters of a wind instrument is used for the generation of the sound data sequence Z. Accordingly, it is possible to generate the sound data sequence Z of natural musical instrument sounds that appropriately reflect differences in the attack in accordance with features of the blowing action of a wind instrument.

### C: Third Embodiment

In the first and second embodiments, an example was presented in which the sound data sequence Z representing wind instrument sounds is generated. The sound generation system 10 of the third embodiment generates a sound data sequence Z that represents bowed string instrument sounds as the target sounds. A bowed string instrument is a string instrument that produces sound by rubbing (that is, friction) a string with a bow. Examples of bowed string instruments include the violin, the viola, and the cello.

The second control data sequence Y (and the playing style data P) in the third embodiment represents features (hereinafter referred to as “bowing parameters”) relating to how to move a bow (i.e., bowing) of the bowed string instrument with respect to the string. For example, the bowing parameters include bowing direction (up-bow/down-bow) and bow speed. The acoustic characteristics of the attack of a bowed string instrument sound change in accordance with the bowing parameters. That is, the second control data sequence Y (and the playing style data P) of the third embodiment is data representing a performance motion for controlling the attack of a musical instrument sound, in the same manner as the second control data sequence Y of the first and second embodiments.

The playing style data Pt used in the first learning process Sa specifies the bowing parameters for each note of the reference musical piece. The second control data sequence Yt of each unit time interval represents the bowing parameters specified by the playing style data Pt for the musical note that includes said unit time interval. Accordingly, the generative model Ma constructed by the first learning process Sa outputs the playing style data P representing the bowing parameters that are statistically appropriate for the note data sequence N.

The reference signal R used in the second learning process Sb is a signal representing the waveform of the musical instrument sound that is produced from the bowed string instrument, when the reference musical piece is played using the bowing parameters specified by the playing style data Pt. Accordingly, the generative model Mb constructed by the second learning process Sb generates the sound data sequence Z of target sounds in which the bowing parameters represented by the second control data sequence Y are appropriately reflected on the attack.

The same effects as those of the first embodiment are realized in the third embodiment. In addition, in the third embodiment, the second control data sequence Y representing bowing parameters of a bowed string instrument is used for the generation of the sound data sequence Z. Accordingly, it is possible to generate the sound data sequence Z of natural musical instrument sounds that appropriately reflect differences in the attack in accordance with features of the bowing of a bowed string instrument.

It should be noted that musical instruments corresponding to the target sounds are not limited to wind instruments and bowed string instruments illustrated above, and can be any instrument. In addition, the performance motions represented by the second control data sequence Y are various motions in accordance with the type of the musical instrument corresponding to the target sound.

### D: Fourth Embodiment

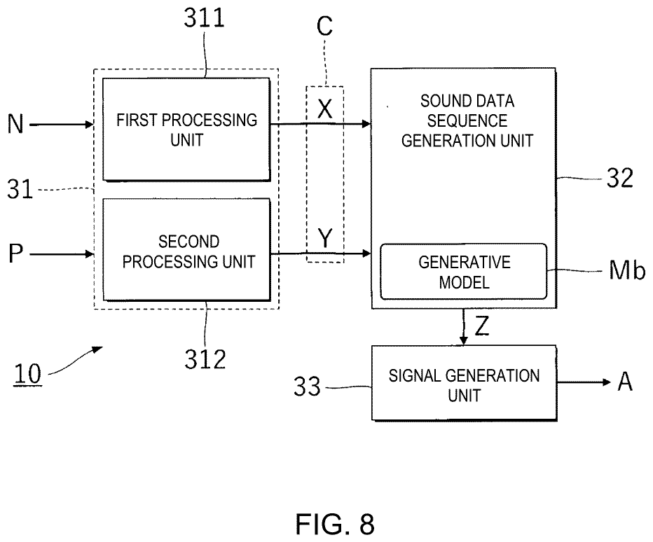

FIG. 8 is a block diagram showing a functional configuration of the sound generation system 10 according to a fourth embodiment. The control device 11 realizes the same functions as those of the first embodiment (control data sequence acquisition unit 31, sound data sequence generation unit 32, and signal generation unit 33) by the execution of a program that is stored in the storage device 12.

The storage device 12 of the fourth embodiment stores playing style data P in addition to the music data D similar to those of the first embodiment. The playing style data P are specified by a user of the sound generation system 10 and stored in the storage device 12. As described above, the playing style data P specify a performance motion for each note of a musical piece represented by the music data D. Specifically, the playing style data P specify one of the six types of tonguing described above, or specify that tonguing does not occur, for each note of the reference musical piece. The playing style data P can be included in the music data D. In addition, the playing style data P stored in the storage device 12 can be the playing style data P of all notes estimated by processing a corresponding note data sequence for each of all the notes of the music data D using the generative model Ma.

The first processing unit 311 generates the first control data sequence X from the note data sequence N for each unit time interval, in the same manner as in the first embodiment. The second processing unit 312 generates the second control data sequence Yt from the playing style data P for each unit time interval. Specifically, for each unit time interval, the second processing unit 312 generates the second control data sequence Y representing the performance motion specified by the playing style data P for the note that includes said unit time interval. The format of the second control data sequence Y is the same as in the first embodiment. In addition, the operations of the sound data sequence generation unit 32 and the signal generation unit 33 are the same as those in the first embodiment.

The same effects that are realized in the first embodiment are realized in the fourth embodiment. In the fourth embodiment, the performance motion of each note is specified by the playing style data P, so the generative model Ma is not required for the generation of the second control data sequence Y. On the other hand, in the fourth embodiment, it is necessary to prepare the playing style data P for each musical piece. In the first embodiment described above, the generative model Ma estimates the playing style data P from the note data sequence N, and the second control data sequence Y is generated from the playing style data P. Therefore, it is not necessary to prepare the playing style data P for each musical piece. In addition, according to the first embodiment, there is the advantage that it is possible to generate the second control data sequence Y that specifies a performance motion that is appropriate for the note sequence, even for new musical pieces for which the playing style data P have not been generated.

In the fourth embodiment, an example of a configuration was presented based on the first embodiment, but the fourth embodiment can be similarly applied to the second embodiment in which the second control data sequence Y represents blowing parameters of a wind instrument, and to the third embodiment in which the second control data sequence Y represents bowing parameters of a bowed string instrument.

### E: Fifth Embodiment

In the first embodiment, an example was presented in which the second control data sequence Y (and the playing style data P) is formed by six elements E_1 to E_6 corresponding to different types of tonguing. That is, one element E of the second control data sequence Y corresponds to one type of tonguing. In the fifth embodiment, the format of the second control data sequence Y is different from that in the first embodiment. In the fifth embodiment, in addition to the six types of the first embodiment, the following five types (t, d, l, M, and N) of tonguing are considered.

In t-tonguing, while the tongue movement during performance is the same as that of T-tonguing, the attack is weaker than in T-tonguing. It can be said that t-tonguing is tonguing in which the slope of the rise is more gradual than that of T-tonguing. In d-tonguing, while the tongue movement during performance is the same as that of D-tonguing, the attack is weaker than in D-tonguing. It can be said that d-tonguing is tonguing in which the slope of the rise is more gradual than that of D-tonguing. In l-tonguing, while the tongue movement during performance is the same as that of L-tonguing, the attack is weaker than in L-tonguing. M-tonguing is a tonguing type in which sounds are separated by changing the shape of the oral cavity or the lips. N-tonguing is a tonguing type that is weak enough that the sound is not cut off.

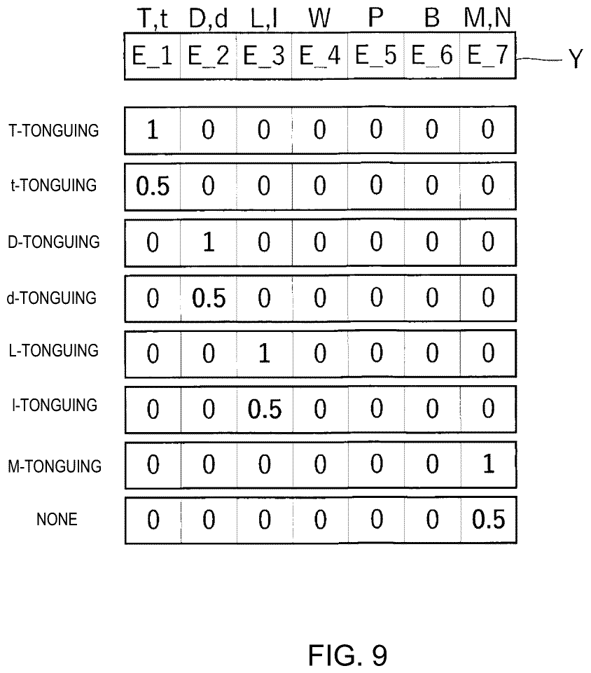

FIG. 9 is a schematic diagram of the second control data sequence Y according to the fifth embodiment. The second control data sequence Y (and the playing style data P) of the fifth embodiment is formed by seven elements E_1 to E_7.

Element E_1 corresponds to T-and t-tonguing. Specifically, in the second control data sequence Y representing T-tonguing, the element E_1 is set to “1” and the remaining six elements E_2 to E_7 are set to “0.” On the other hand, in the second control data sequence Y representing t-tonguing, the element E_1 is set to “0.5” and the remaining six elements E_2 to E_7 are set to “0.” As described above, one element E to which two types of tonguing are assigned is set to different numerical values corresponding to each of the two types.

Element E_2 corresponds to D-and d-tonguing, and element E_3 corresponds to L- and 1-tonguing. Elements E_4 to E_6 correspond to one type of tonguing (W, P, B), in the same manner as in the first embodiment. In addition, element E_7 corresponds to M-and N-tonguing.

The same effects that are realized in the first embodiment are realized in the fifth embodiment. In addition, in the fifth embodiment, one element of the second control data sequence Y (and the playing style data P) is set to one of a plurality of numerical values corresponding to different types of tonguing. Therefore, there is the advantage that a variety of tonguing can be expressed while reducing the number of elements E that constitute the second control data sequence Y.

### F: Modified Examples

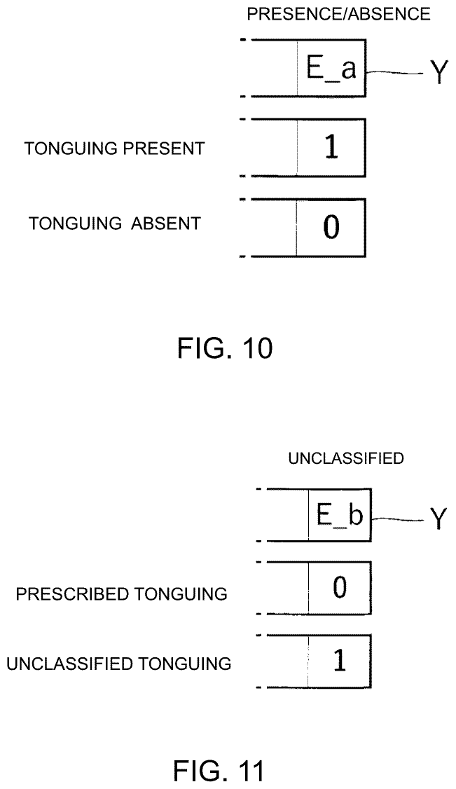

Specific modified embodiments to be added to each of the embodiments exemplified above are illustrated below. A plurality of embodiments selected at random from the following examples can be appropriately combined as long as they are not mutually contradictory.
(1) In each of the embodiments described above, an example was presented in which the second control data sequence Y (and the playing style data P) is formed by a plurality of elements E corresponding to one or more types of tonguing, but the format of the second control data sequence Y is not limited to the examples described above. For example, as shown in FIG. 10, it is possible to envision a configuration in which the second control data sequence Y includes one element E_a representing presence/absence of tonguing. In the second control data sequence Y representing any one type of tonguing, the element E_a is set to “1,” and in the second control data sequence Y representing the absence of tonguing, the element E_a is set to “0.”

In addition, as shown in FIG. 11, the second control data sequence Y can include an element E_b corresponding to an unclassified tonguing type that cannot be classified into any of the types illustrated in the embodiments described above. In the second control data sequence Y representing an unclassified tonguing, the element E_b is set to “1” and the remaining elements E are set to “0.”

The second control data sequence Y (and the playing style data P) is not limited to data in a format formed by a plurality of elements E. For example, identification information for identifying each of a plurality of types of tonguing can be used as the second control data sequence Y.
(2) In each of the embodiments described above, an example was presented in which one of the plurality of elements E of the second control data sequence Y (and the playing style data P) is selectively set to “1” and the remaining elements E are set to “0,” but two or more of the plurality of elements E can be set to a positive number other than “0.”

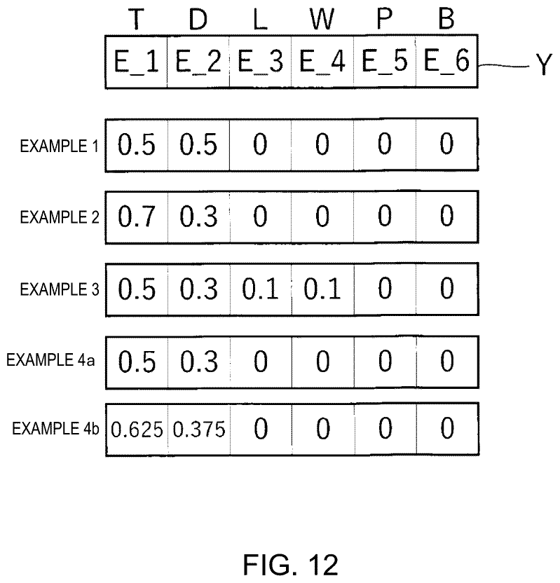

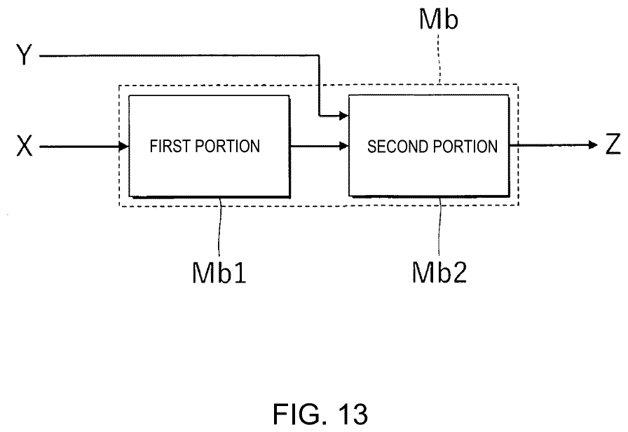

For example, tonguing that has intermediate properties between two types of tonguing (hereinafter referred to as “target tonguing”) is expressed by the second control data sequence Y in which two of the plurality of elements E that correspond to the target tonguing are set to a positive number. The second control data sequence Y shown as Example 1 in FIG. 12 specifies an intermediate tonguing between T-target tonguing and D-target tonguing. In Example 1, element E_1 and element E_2 are set to “0.5” and the remaining elements E (E_3 to E_6) are set to “0.” According to the embodiment described above, it is possible to generate the second control data sequence Y reflecting a plurality of types of tonguing.

In addition, tonguing that is similar to two types of target tonguing but to different degrees is expressed by the second control data sequence Y in which the two elements E corresponding to the target tonguing types are set to different numerical values. The second control data sequence Y shown as Example 2 in FIG. 12 specifies an intermediate tonguing between T-target tonguing and D-target tonguing. However, the tonguing specified by the second control data sequence Y is more similar to T-target tonguing than to D-target tonguing. Therefore, the element E_1 of the T-target tonguing is set to a numerical value that is larger than the element E_2 of the D-target tonguing. Specifically, the element E_1 is set to “0.7” and the element E_2 is set to “0.3.” That is, the element E corresponding to each tonguing type is set to the likelihood of corresponding to said tonguing type (that is, the degree of similarity to that tonguing). According to the embodiment described above, it is possible to generate the second control data sequence Y in which the relationship between a plurality of types of tonguing is precisely reflected.

In FIG. 12, tonguing that is intermediate between two types of target tonguing is assumed, but intermediate tonguing between three or more types of tonguing can be expressed in a similar manner. For example, as shown as Example 3 in FIG. 12, tonguing that is intermediate between four types of target tonguing (T, D, L, W) is expressed by the second control data sequence Y in which four elements E that respectively correspond to the target tonguing types are set to a positive number.

In addition, it can be configured such that, of the plurality of types of tonguing, only the elements E of a prescribed number of target tonguing types ranked at the top in descending order of likelihood are set to positive numbers. For example, as shown as Example 4a or 4b in FIG. 12, it can be configured such that only elements E (E_1, E_2) of two types of target tonguing selected in descending order of likelihood from among four types of target tonguing (T, D, L, W) are set to positive numbers. Example 4a is a configuration in which only top two elements E (Element E_1, E_2) in descending order of likelihood are set to positive numbers and the remaining four elements E (E_3 to E_6) are set to “0.” On the other hand, Example 4b is a configuration in which the numerical values of the elements E are adjusted so that the sum of the plurality of elements E (E_1 to E_6) in Example 4a becomes “1.”

In an embodiment in which the sum of a plurality of elements E of the second control data sequence Y becomes “1,” a Softmax function is used as the loss function of the generative model Ma, for example. Similarly, the generative model Mb is constructed through machine learning using a Softmax function as the loss function.
(3) In each of the embodiments described above, an example was presented in which the sound data sequence Z represents the frequency spectrum envelope of the target sound, but the information represented by the sound data sequence Z is not limited to the example described above. For example, a configuration in which the sound data sequence Z represents each sample of the target sound is also conceivable. In the mode described above, a time series of the sound data sequence Z constitutes the sound signal A. Therefore, the signal generation unit 33 is omitted.
(4) In each of the embodiments described above, an example was presented in which the control data sequence acquisition unit 31 generates the first control data sequence X and the second control data sequence Y, but the operation of the control data sequence acquisition unit 31 is not limited to the example described above. For example, the control data sequence acquisition unit 31 can receive, from an external device, the first control data sequence X and the second control data sequence Y generated by said external device with the communication device 13. In addition, in a configuration in which the first control data sequence X and the second control data sequence Y are stored in the storage device 12, the control data sequence acquisition unit 31 reads the first control data sequence X and the second control data sequence Y from the storage device 12. As can be understood from the examples described above, the “acquisition” by the control data sequence acquisition unit 31 encompasses any operation of acquiring the first control data sequence X and the second control data sequence Y, such as generation, reception, readout, etc., of the first control data sequence X and the second control data sequence Y. Similarly, “acquisition” of the first control data sequence Xt and the second control data sequence Yt by the training data acquisition unit 40 encompasses any operation (such as generation, reception, and readout) of acquiring the first control data sequence Xt and the second control data sequence Yt.
(5) In each of the embodiments described above, an example was presented in which the control data sequence C obtained by concatenating the first control data sequence X and the second control data sequence Y is supplied to the generative model Mb, but the input mode of the first control data sequence X and the second control data sequence Y to the generative model Mb is not limited to the example described above.

For example, as shown in FIG. 13, a configuration in which the generative model Mb is formed by a first portion Mb1 and a second portion Mb2 will be considered. The first portion Mb1 is a portion formed by an input layer and a part of an intermediate layer of the generative model Mb. The second portion Mb2 is a portion formed by the other part of the intermediate layer and an output layer of the generative model Mb. In the configuration described above, the first control data sequence X can be supplied to the first portion Mb1 (input layer), and the second control data sequence Y can be supplied to the second portion Mb2 together with data output from the first portion Mb1. As can be understood from the example described above, the concatenation of the first control data sequence X and the second control data sequence Y is not essential in the present disclosure.
(6) In each of the embodiments described above, the note data sequence N is generated from the music data D stored in the storage device 12 in advance, but a note data sequence N sequentially supplied from a performance device can be used instead. The performance device is an input device that receives a user's performance, such as a MIDI keyboard, and that sequentially outputs the note data sequence N corresponding to the user's performance. The sound generation system 10 uses the note data sequence N supplied from the performance device to generate the sound data sequence Z. The above-mentioned synthesis process S can be executed in real time in parallel with the user's performance on the performance device. Specifically, the second control data sequence Y and the sound data sequence Z can be generated in parallel with the user's operation of the performance device.
(7) In each of the embodiments described above, the playing style data Pt are generated in accordance with the performer's instruction, but the playing style data Pt can be generated using an input device, such as a breath controller. The input device is a detection device that detects blowing parameters such as the performer's breath volume (inspiration volume, expiration volume) or breath speed (inspiration speed, expiration speed). The blowing parameters are dependent on the types of tonguing. Therefore, the playing style data Pt are generated using the blowing parameters. For example, if the expiration speed is low, playing style data Pt specifying L-tonguing are generated. If the expiration speed is high and change in the expiration volume is rapid, playing style data Pt specifying T-tonguing are generated. The foregoing is not limited to blowing parameters; for example, the tonguing type can be specified in accordance with linguistic features of the recorded sound. For example, T-tonguing is specified when a Japanese character in the ‘ta’ row is recognized, D-tonguing is specified when a voiced consonant character is recognized, and L-tonguing is specified when a character in the ‘ra’ row is recognized.
(8) In each of the embodiments described above, a deep neural network is illustrated as an example, but the generative model Ma and the generative model Mb are not limited to deep neural networks. For example, a statistical model of any type and format, such as a Hidden Markov Model (HMM) or a Support Vector Machine (SVM), can be used as the generative model Ma or the generative model Mb.
(9) In each of the embodiments described above, a generative model Ma that has learned the relationship between the note data sequence N and tonguing types (playing style data P) is used, but the method and configuration for generating tonguing types from the note data sequence N are not limited to the example described above. For example, a reference table in which a tonguing type is associated with each of a plurality of note data sequences N can be used for the generation of the second control data sequence Y by the second processing unit 312. The reference table is a data table in which the correspondence between the note data sequence °N and the tonguing type is registered and is stored, for example, in the storage device 12. The second processing unit 312 searches for the tonguing type corresponding to the note data sequence N from the reference table and outputs the second control data sequence Y that specifies said tonguing type for each unit time interval.
(10) In each of the embodiments described above, the machine learning system 20 constructs the generative model Ma and the generative model Mb, but functions for constructing the generative model Ma (training data acquisition unit 40 and first learning processing unit 41) and/or functions for constructing the generative model Mb (training data acquisition unit 40 and second learning processing unit 42) can be provided in the sound generation system 10.
(11) For example, it is possible to realize the sound generation system 10 with a server device that communicates with information devices, such as smartphones or tablet terminals. For example, the sound generation system 10 receives the note data sequence N from the information device and generates the sound signal A using the synthesis process S to which the note data sequence N is applied. The sound generation system 10 transmits, to the information device, the sound signal A generated through the synthesis process S. In a configuration in which the signal generation unit 33 is installed in the information device, a time series of the sound data sequence Z is transmitted to the information device. That is, the signal generation unit 33 is omitted from the sound generation system 10.
(12) As described above, the functions of the sound generation system 10 (control data sequence acquisition unit 31, sound data sequence generation unit 32, and signal generation unit 33) are realized by cooperation between one or a plurality of processors that constitute the control device 11, and a program stored in the storage device 12. In addition, the functions of the machine learning system 20 (training data acquisition unit 40, first learning processing unit 41, and second learning processing unit 42) are realized by cooperation between one or a plurality of processors that constitute the control device 21, and a program stored in the storage device 22.

The program exemplified above can be stored on a computer-readable storage medium and installed in a computer. The storage medium is, for example, a non-transitory storage medium, a good example of which is an optical storage medium (optical disc) such as a CD-ROM, but can include storage media of any known form, such as a semiconductor storage medium or a magnetic storage medium. Non-transitory storage media include any storage medium that excludes transitory propagating signals and does not exclude volatile storage media. In addition, in a configuration in which a distribution device distributes the program via the communication network 200, a storage medium that stores the program in the distribution device corresponds to the non-transitory storage medium.

### G: Additional Statement

For example, the following configurations can be understood from the embodiments exemplified above.

A sound generation method according to one aspect (Aspect 1) comprises: acquiring a first control data sequence representing a feature of a note sequence and a second control data sequence representing a performance motion for controlling an attack of a musical instrument sound corresponding to each note of the note sequence; and processing the first control data sequence and the second control data sequence with a trained first generative model to generate a sound data sequence representing a musical instrument sound of the note sequence having an attack corresponding to a performance motion represented by the second control data sequence. In the aspect described above, in addition to the first control data representing a feature of a note sequence, the second control data sequence representing a performance motion for controlling an attack of a musical instrument sound corresponding to each note of the note sequence is used for the generation of the sound data sequence. Accordingly, compared to a configuration in which the sound data sequence is generated only from the first control data sequence, it is possible to generate the sound data sequence of musical instrument sounds with an appropriate attack added to the note sequence.

The “first control data sequence” is data (first control data) of a given format representing a feature of a note sequence and is generated from a note data sequence representing a note sequence, for example. In addition, the first control data sequence can be generated from a note data sequence that is generated in real time in accordance with an operation on an input device, such as an electronic instrument. The “first control data sequence” is, in other words, data that specify the conditions of musical instrument sounds to be synthesized. For example, the “first control data sequence” specifies various conditions relating to each note constituting a note sequence, such as the pitch or duration of each note constituting a note sequence, the relationship between the pitch of one note and the pitches of other notes located around said note, and the like.

“Musical instrument sound” is sound produced from an instrument by playing said instrument. An “attack” of a musical instrument sound is the initial rising portion of the musical instrument sound. The “second control data sequence” is data (second control data) in a given format representing a performance motion that affects the attack of the musical instrument sound. The second control data sequence is, for example, data added to a note data sequence, data generated by processing a note data sequence, or data corresponding to an instruction from a user.

The “first generative model” is a trained model in which the relationship between the sound data sequence, and the first control data sequence and the second control data sequence, is learned through machine learning. A plurality of pieces of training data are used for the machine learning of the first generative model. Each piece of training data includes a set of a first training control data sequence and second training control data sequence, and a training sound data sequence. The first training control data sequence is data representing a feature of a reference note sequence, and the second training control data sequence is data representing a performance motion suitable for the performance of the reference note sequence. The training sound data sequence represents musical instrument sounds that are produced when a reference note sequence corresponding to the first training control data sequence is played with the performance motion corresponding to the second training control data sequence. For example, various statistical estimation models such as a deep neural network (DNN), a hidden Markov model (HMM), or a support vector machine (SVM) are used as the “first generative model.”

Any mode can be used to input the first control data sequence and the second control data sequence to the first generative model. For example, input data containing the first control data sequence and the second control data sequence are input to the first generative model. In a configuration in which the first generative model includes an input layer, a plurality of intermediate layers, and an output layer, a configuration in which the first control data sequence is input to the input layer and the second control data sequence is input to the intermediate layer is conceivable. That is, it is not necessary to concatenate the first control data sequence and the second control data sequence.

The “sound data sequence” is data (sound data) of a given format representing a musical instrument sound. For example, data representing acoustic characteristics (frequency spectrum envelope) such as intensity spectrum, Mel spectrum, and Mel-frequency cepstral coefficients (MFCC), are examples of the “sound data sequence.” In addition, a sample sequence representing the waveform of a musical instrument sound can be generated as the “sound data sequence.”

In a specific example (Aspect 2) of Aspect 1, the first generative model is a model trained using training data containing: a first training control data sequence representing a feature of a reference note sequence, and a second training control data sequence representing a performance motion for controlling an attack of a musical instrument sound corresponding to each note of the reference note sequence; and a training sound data sequence representing a musical instrument sound of the reference note sequence. According to the aspect described above, it is possible to generate a statistically appropriate sound data sequence from the viewpoint of the relationship between the first training control data sequence and second training control data sequence of a reference note sequence, and the training sound data sequence representing the musical instrument sound of said reference note sequence.

In a specific example (Aspect 3) of Aspect 1 or Aspect 2, when acquiring the first control data sequence and the second control data sequence, the first control data sequence is generated from a note data sequence representing the note sequence, and the second control data sequence is generated by processing the note data sequence using a trained second generative model. According to the aspect described above, the second control data sequence is generated by processing the note data sequence using the second generative model. Therefore, it is not necessary to prepare playing style data representing the performance motions of the musical instrument sounds for each musical piece. In addition, it is possible to generate a second control data sequence representing appropriate performance motions even for new musical pieces.

In a specific example (Aspect 4) of any one of Aspects 1 to 3, the second control data sequence represents a feature relating to tonguing of a wind instrument. In the aspect described above, a second control data sequence representing a feature relating to tonguing of a wind instrument is used for the generation of the sound data sequence. Accordingly, it is possible to generate the sound data sequence of natural musical instrument sounds that appropriately reflect differences in the attack in accordance with tonguing features.

A “feature relating to tonguing of a wind instrument” is a feature such as whether the tongue or the lips are used for the tonguing. With regard to tonguing that uses the tongue, a feature relating to the tonguing method, such as tonguing in which the difference in volume between the sustain and the peak of the attack is large (voiceless consonant), tonguing in which said difference in volume is small (voiced consonant), and tonguing in which no change is observed between the attack and the decay, can be specified by the second control data sequence. In addition, with regard to tonguing that uses the lips, a feature relating to the tonguing method, such as tonguing using opening and closing of the lips themselves, tonguing in which the opening and closing of the lips themselves are used to produce a louder sound, and tonguing in which the opening and closing of the lips themselves are used to produce a sound in the same manner as a voiced consonant, can be specified by the second control data sequence.

In a specific example (Aspect 5) of any one of Aspects 1 to 3, the second control data sequence represents a feature relating to inspiration or expiration when blowing a wind instrument. In the aspect described above, a second control data sequence representing a feature relating to inspiration or expiration when blowing a wind instrument is used for the generation of the sound data sequence. Accordingly, it is possible to generate the sound data sequence of natural musical instrument sounds that appropriately reflect differences in the attack in accordance with features of blowing. A “feature relating to inspiration or expiration when blowing a wind instrument” is, for example, the intensity (for example, inspiration volume, inspiration speed, expiration volume, or expiration speed) of the inspiration or expiration.

In a specific example (Aspect 6) of any one of Aspects 1 to 3, the second control data sequence represents a feature relating to bowing of a bowed string instrument. In the aspect described above, a second control data sequence representing a feature relating to bowing of a bowed string instrument is used for the generation of the sound data sequence. Accordingly, it is possible to generate the sound data sequence of natural musical instrument sounds that appropriately reflect differences in the attack in accordance with features of bowing. A “feature relating to bowing of a bowed string instrument” is, for example, the bowing direction “up-bow/down-bow” or bow speed.

In a specific example (Aspect 7) of any one of Aspects 1 to 6, in each of a plurality of unit time intervals on a time axis, acquisition of the first control data sequence and the second control data sequence, and generation of the sound data sequence are executed.

A sound generation system according to one aspect (Aspect 8) comprises: a control data sequence acquisition unit for acquiring a first control data sequence representing a feature of a note sequence and a second control data sequence representing a performance motion for controlling an attack of a musical instrument sound corresponding to each note of the note sequence; and a sound data sequence generation unit for processing the first control data sequence and the second control data sequence with a trained first generative model to generate a sound data sequence representing a musical instrument sound of the note sequence having an attack corresponding to a performance motion represented by the second control data sequence.

A program according to one aspect (Aspect 9) causes a computer system to function as a control data sequence acquisition unit for acquiring a first control data sequence representing a feature of a note sequence and a second control data sequence representing a performance motion for controlling an attack of a musical instrument sound corresponding to each note of the note sequence; and a sound data sequence generation unit for processing the first control data sequence and the second control data sequence with a trained first generative model to generate a sound data sequence representing a musical instrument sound of the note sequence having an attack corresponding to a performance motion represented by the second control data sequence.

What is claimed is:

1. A sound generation method realized by a computer system, the sound generation method comprising:
acquiring a first control data sequence representing a feature of a note sequence and a second control data sequence representing a performance motion for controlling an attack of a musical instrument sound corresponding to each note of the note sequence; and
processing the first control data sequence and the second control data sequence with a trained first generative model, thereby generating a sound data sequence representing a musical instrument sound of the note sequence having an attack corresponding to the performance motion represented by the second control data sequence.

2. The sound generation method according to claim 1, wherein
the trained first generative model is a model trained using training data containing
a first training control data sequence representing a feature of a reference note sequence, and a second training control data sequence representing a performance motion for controlling an attack of a musical instrument sound corresponding to each note of the reference note sequence; and
a training sound data sequence representing a musical instrument sound of the reference note sequence.

3. The sound generation method according to claim 1, wherein
in the acquiring of the first control data sequence and the second control data sequence,
the first control data sequence is generated from a note data sequence representing the note sequence, and
the second control data sequence is generated by processing the note data sequence using a trained second generative model.

4. The sound generation method according to claim 1, wherein
the second control data sequence represents a feature relating to tonguing of a wind instrument.

5. The sound generation method according to claim 1, wherein
the second control data sequence represents a feature relating to inspiration or expiration in blowing of a wind instrument.

6. The sound generation method according to claim 1, wherein
the second control data sequence represents a feature relating to bowing of a bowed string instrument.

7. The sound generation method according to claim 1, wherein
in each of a plurality of unit time intervals on a time axis,
the acquiring of the first control data sequence and the second control data sequence, and the generating of the sound data sequence are executed.

8. A sound generation system comprising:
an electronic controller including at least one processor configured to acquire a first control data sequence representing a feature of a note sequence and a second control data sequence representing a performance motion for controlling an attack of a musical instrument sound corresponding to each note of the note sequence; and
process the first control data sequence and the second control data sequence with a trained first generative model, thereby generating a sound data sequence representing a musical instrument sound of the note sequence having an attack corresponding to the performance motion represented by the second control data sequence.

9. The sound generation system according to claim 8, wherein the trained first generative model is a model trained using training data containing
a first training control data sequence representing a feature of a reference note sequence, and a second training control data sequence representing a performance motion for controlling an attack of a musical instrument sound corresponding to each note of the reference note sequence; and
a training sound data sequence representing a musical instrument sound of the reference note sequence.

10. The sound generation system according to claim 8, wherein
the at least one processor is configured to generate the first control data sequence from a note data sequence representing the note sequence to acquire the first control data sequence, and
the at least one processor is configured to the second control data sequence is generated by processing the note data sequence using a trained second generative model to acquire the second control data sequence.

11. The sound generation system according to claim 8, wherein
the second control data sequence represents a feature relating to tonguing of a wind instrument.

12. The sound generation system according to claim 8, wherein
the second control data sequence represents a feature relating to inspiration or expiration in blowing of a wind instrument.

13. The sound generation system according to claim 8, wherein
the second control data sequence represents a feature relating to bowing of a bowed string instrument.

14. The sound generation system according to claim 8, wherein
the at least one processor is configured to acquire the first control data sequence and the second control data sequence and generate the sound data sequence are executed in each of a plurality of unit time intervals on a time axis.

15. A non-transitory computer-readable medium storing a program that causes a computer system to execute a process, the process comprising:
acquiring a first control data sequence representing a feature of a note sequence and a second control data sequence representing a performance motion for controlling an attack of a musical instrument sound corresponding to each note of the note sequence; and
processing the first control data sequence and the second control data sequence with a trained first generative model, thereby generating a sound data sequence representing a musical instrument sound of the note sequence having an attack corresponding to the performance motion represented by the second control data sequence.
